(19) United States
(12) Patent Application Publication
(10) Pub. No.: US 2026/0081449 A1
(43) Pub. Date: Mar. 19, 2026

(54) INTEGRATED MULTIPORT HYBRID MICROINVERTER

(71) Applicant: University of Central Florida Research Foundation, Inc., Orlando, FL (US)

(72) Inventors: Issa Batarseh, Orlando, FL (US); Reza Rezaii, Orlando, FL (US); Mohammad Nilian, Orlando, FL (US); Russell Case, Oviedo, FL (US)

(21) Appl. No.: 19/270,956

(22) Filed: Jul. 16, 2025

Related U.S. Application Data
(60) Provisional application No. 63/695,111, filed on Sep. 16, 2024.

(51) Int. Cl. H02J 7/00; H02J 7/35; H02M 3/335; H02M 7/537

(52) U.S. Cl. CPC H02J 7/865; H02J 7/35; H02M 3/33584; H02M 7/537; H02J 2207/20

(57) ABSTRACT

A device and method for an integrated photovoltaic power module. A module include a photovoltaic cell, a rechargeable battery, an alternating current electrical port, and a microinverter. The microinverter has a first link at a first voltage coupled to the photovoltaic cell, a second link at a second voltage, and a boost converter converting power between the first link and the second link. The module includes a DC-to-AC power converter exchanging electrical power between the second link and the alternating current electrical port at an AC voltage. The module has a battery voltage converter with a battery port electrically connected to the rechargeable battery and a first link port connected to the first link and converting between a voltage of the rechargeable battery and a voltage of the first link.

This invention was made with Government support under National Science Foundation Award No.: 2208341. The Government has certain rights in the invention.

### TECHNICAL FIELD

The present invention is directed to integrated solar power systems, and more particularly to integrated solar power systems comprising a battery and an integrated hybrid microinverter.

### BACKGROUND

Developments in renewable energy generation system designs, such as solar photovoltaic cells, have made smaller solar energy generation devices economically practical. A challenge with many renewable energy sources, such as photovoltaic cells, is the intermittent availability of sunlight to energize those cells.

### BRIEF DESCRIPTION THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a hybrid microinverter system block diagram, according to an example;

FIG. 2 illustrates views of a hybrid microinverter system, according to an example;

FIG. 3 illustrates a first hybrid microinverter system block diagram with a non-isolated hybrid microinverter configuration, according to an example;

FIG. 4 illustrates a second hybrid microinverter system block diagram with an isolated hybrid microinverter configuration, according to an example;

FIG. 5 illustrates a third microinverter system block diagram, according to an example;

FIG. 6 illustrates a bidirectional buck-boost converter block diagram, according to an example;

FIG. 7 illustrates a Capacitor Inductor Inductor Capacitor (CLLC) converter block diagram, according to an example;

FIG. 8 depicts a method of providing an integrated photovoltaic power module, according to an example; and

FIG. 9 depicts a method of providing electrical power from a photovoltaic module, according to an example.

### DETAILED DESCRIPTION

The below describes methods and systems that include a highly integrated hybrid microinverter system that has three (3) ports that can be connected to a photovoltaic (PV) cell, an energy storage battery, and an Alternating Current (AC) electrical port. The system has several modes of operation to transfer electrical energy between these different ports. The system includes a hybrid microinverter that is sized to process the electrical power produced by a connected PV cell and output that power as AC electrical power. In some examples, these hybrid microinverter systems are integrated into a single unit with PV cell(s) and energy storage systems such as batteries to form a complete system. The below described systems and methods provide a sustainable source that can be formed into a grid where several such systems can be connected to each other to supply the same load, exchange electrical power with a larger electrical power grid, or both.

Some examples of such hybrid microinverters, which are examples of multi-port/multi-mode inverters, serve as versatile devices aimed at optimizing the integration of renewable energy sources, particularly photovoltaic (PV) cells, with energy storage systems and the traditional electrical grid or AC load. These designs facilitate efficient management and enhancement of renewable energy utilization, allowing for seamless operation within diverse energy environments.

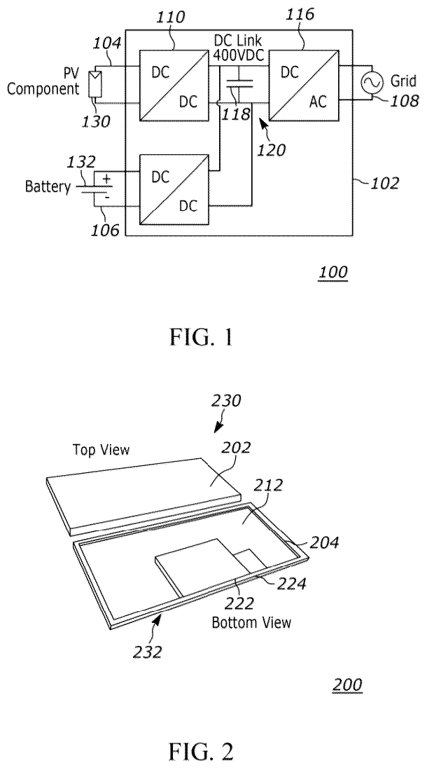

FIG. 1 illustrates a hybrid microinverter system block diagram 100, according to an example. The hybrid microinverter system block diagram 100 is an example the comprehensive functionality and integration capabilities of a hybrid microinverter.

The hybrid microinverter system block diagram 100 depicts a hybrid microinverter 102 that operates to exchange energy with three (3) ports. The hybrid microinverter system block diagram 100 depicts a Photovoltaic (PV) component 130. The PV component 130 is able to consist of one or more PV cells that sends DC electrical power into a PV port 104 of the hybrid microinverter 102 for delivery to a first DC-to-DC converter 110. A battery 132 is connected to a battery port 106 to exchange DC electrical energy with a second DC-to-DC converter 112. The first DC-to-DC converter 110 and the second DC-to-DC converter 112 exchange DC electrical energy with a general DC link 120. The general DC link 120 is shown to have a link capacitor 118 to stabilize its DC voltage. In various examples, as is described in further detail below, the general DC link 120 is able to consist of one or more DC-to-DC voltage converters, DC links, and link capacitors. The hybrid microinverter system block diagram 100 further includes a DC to AC converter 116 that exchanges electrical energy between the general DC link 120 and an AC grid connection 108. In some examples, the DC to AC converter 116 is able to exchange electrical energy in either direction to deliver electrical energy to the AC grid connection 108 or receive energy from the AC grid connection 108.

FIG. 2 illustrates views of a hybrid microinverter system 200, according to an example. The views of the hybrid microinverter system 200 show an example of a device that implements the hybrid microinverter system block diagram 100 discussed above. This implementation enhances electrical power accessibility to various locations and installations by providing an easily manufactured and deployable device that integrates hybrid microinverters and battery storage with PV panel-level solar generators. Such implementations facilitates the rapid and scalable deployment of PV generators that are easily deployable in a variety of scenarios.

The views of a hybrid microinverter system 200 depicts a front view 230 and a back view 232 of an example hybrid microinverter system. The illustrated hybrid microinverter system integrates at least one photovoltaic cell 202, a rechargeable battery 222, and a hybrid microinverter 224 that are all physically attached to a housing. An illustrated frame 204 is an example of such a housing. The frame 204 provides physical mounting for the rechargeable battery 222, the hybrid microinverter 224, and the photovoltaic cell 202 that are all mounted on the frame 204. In an example, the hybrid microinverter 224 is similar to the above discussed hybrid microinverter 102 and provides an alternating current electrical port, such as to the AC grid connection 108 depicted in FIG. 1, that serves as an alternating current electrical port of the frame or housing of the integrated photovoltaic power module.

### Some Features of a Hybrid Microinverter Include

1. Grid-Tie Capability: Hybrid inverters can be configured to operate in a grid-tie mode, allowing excess energy generated by PV cells to be fed back into the grid, often earning credits or compensation. In the grid-tie operation, the converter can operate in a grid-forming mode, a grid following mode, or both.
2. Off-Grid Operation: These inverters can also be configured to function in an off-grid mode, providing power during periods when the grid is unavailable. They manage energy storage systems, such as batteries, to store excess energy for later use.
3. Energy Management: These systems and methods excel in energy management, intelligently deciding when to draw power from PV cells, batteries, or the grid based on factors like energy demand, solar availability, and battery state of charge.
4. Backup Power: In the event of a grid outage, hybrid microinverters with energy storage capabilities can seamlessly switch to backup power mode, ensuring a continuous and reliable energy supply.

The below described systems and methods incorporating hybrid microinverters offer significant benefits for both residential and commercial applications aiming for energy independence, enhanced resilience, and efficient utilization of renewable energy sources. Currently available hybrid inverters often requiring high voltages on both the PV cells and battery ports.

### Hybrid Microinverters

In various examples, the hybrid microinverter system block diagram 100 is able to include a variety of component designs. In some examples, an example hybrid microinverter system that has components depicted in the hybrid microinverter system block diagram 100 is able to include a hybrid microinverter 102 that is based on one (1) of three (3) different topologies. These different topologies are able to be divided to: 1) isolated; and 2) non-isolated configurations. Examples of these configurations are described below.

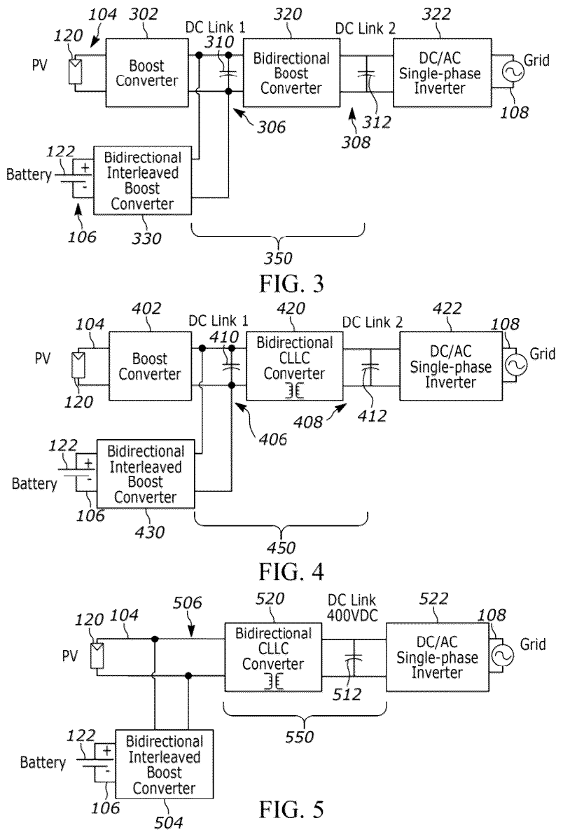

FIG. 3 illustrates a first hybrid microinverter system block diagram with a non-isolated hybrid microinverter configuration 300, according to an example. The first hybrid microinverter system with a non-isolated hybrid microinverter configuration 300 depicts an example design in which there is a single ground for the whole system.

As show in FIG. 3, the first hybrid microinverter system block diagram with a non-isolated hybrid microinverter configuration 300 includes a first boost converter 302, which is an example of a photovoltaic cell output boost converter, that receives DC power from the PV component 130 through the PV port and is also connected to a first DC link 306. In an example, the first DC link 306 is maintained at a first DC voltage of 135 VDC with voltage stabilization provided by a first capacitor 310. A first bidirectional boost converter 320 connects the first DC link 306 to a second DC link 308 and operates to change voltage levels between these two DC links so as to facilitate exchange of electrical energy between the first DC voltage of the first DC link 306 and a second DC voltage of the second DC link 308. The second DC link 308 in this example has a second DC voltage of 400 VDC with voltage stabilization provided by a second capacitor 312. A first example general DC link 350 for the first hybrid microinverter system block diagram with a non-isolated hybrid microinverter configuration 300 includes the first DC link 306, the first bidirectional boost converter 320, and the second DC link 308.

The second DC voltage on the second DC link 308 in this example is connected to a DC/AC single-phase inverter 322 to generate 220 VAC. The DC/AC single-phase inverter 322 is a single-phase inverter, which is an example of a DC-to-AC power converter, that exchanges electrical power between the second DC link 308 with the second DC voltage and the AC grid connection 108 at an AC voltage to provide or receive AC electrical power at the AC grid connection 108 of this example of an integrated photovoltaic power module that is able to be exchanged with a power grid or AC load.

The PV port 104 of the first hybrid microinverter system block diagram with a non-isolated hybrid microinverter configuration 300 is connected to the first boost converter 302, which is an example of a photovoltaic cell output boot converter. The first boost converter 302 in an example also performs maximum power point tracking (MPPT) to track the maximum power point of the PV component 130 by, for example, changing its boost converter operations duty cycle. The first boost converter 302 further electrically couples, indirectly, the power output from the PV component 130 to the first DC link 306.

The battery port 106 in the first hybrid microinverter system block diagram with a non-isolated hybrid microinverter configuration 300 is connected to a bidirectional interleaved boost converter 330, which is an example of a bidirectional battery voltage converter, to support charging and discharging of the battery 132 based on its state of charge. The bidirectional interleaved boost converter 330 couples the battery port 106 and the first DC link 306 where the battery port 106 is electrically connected to a battery 132 that is a rechargeable battery. The bidirectional interleaved boost converter 330 further has a battery converter power port that is connected to the first DC link 306. The bidirectional interleaved boost converter in an example converts between a voltage of the battery 132 and the first DC voltage of the first DC link 306.

FIG. 4 illustrates a second hybrid microinverter system block diagram with an isolated hybrid microinverter configuration 400, according to an example. The second hybrid microinverter system block diagram with an isolated hybrid microinverter configuration 400 depicts an example hybrid microinverter configuration that is in some aspects similar to the above described first hybrid microinverter system block diagram with a non-isolated hybrid microinverter configuration 300. The second hybrid microinverter system block diagram with an isolated hybrid microinverter configuration 400 includes a second boost inverter 402, that is similar to the first boost converter 302, a second DC/AC single-phase inverter 422 that is similar to the above described DC/AC single-phase inverter 322, a first DC link 406 with a first DC voltage stabilized with a first capacitor 410, and a second DC link 408 with a second DC voltage stabilized with a second capacitor 412, which are similar to the first DC link 306 and the second DC link 408 described above, and a bidirectional interleaved boost converter 430 that is similar to the above described bidirectional interleaved boost converter 330.

The second hybrid microinverter system block diagram with an isolated hybrid microinverter configuration 400 includes an isolated bidirectional Capacitor Inductor Inductor Capacitor (CLLC) resonant converter 420, referred to herein as a CLLC converter, with a fixed frequency to change voltages between the first DC link 406 and the second DC link 408. This system is similar to the first configuration with the bidirectional CLLC resonant converter 420 replacing the first bidirectional boost converter 320 to convert DC voltages between the first DC link voltage and the second DC link voltage. The bidirectional CLLC resonant converter 420, as is described below, isolates the ground connections between the first DC link 406 and the second DC link 408. In this example, a second general DC link 450 includes the first DC link 406, the bidirectional CLLC resonant converter 420, and the second DC link 408.

FIG. 5 illustrates a third microinverter system block diagram 500, according to an example. The third microinverter system block diagram 500 depicts an example combination of a bidirectional buck-boost converter 504 with a bidirectional CLLC converter 520 and a DC/AC single-phase inverter 522. In this system, the bidirectional CLLC converter 520 is directly coupled, via a direct link, to the PV port 104 through a first DC link 506 and receives electrical energy from the PV component 130. In an example, the bidirectional CLLC converter 520 operates to adjust the voltage of the first DC link 506 to implement MPPT processes to maximize the electrical power production of the PV component 130.

The third microinverter system block diagram 500 includes a bidirectional buck-boost converter 504 that couples electrical power output from the battery 132, through the battery port 106, to the first DC link 506. As noted above, the first DC link 506 has a variable first DC voltage that corresponds to the voltage of the MPPT voltage as is maintained on the PV component 130 by the bidirectional CLLC converter 520. In such an example, the bidirectional buck-boost converter 504 operates to adjust its output voltage as delivered to the first DC link 506 to match the voltage corresponding to the MPPT voltage maintained by the bidirectional CLLC converter 520. In some examples, the bidirectional CLLC converter 520 is able to operate to provide power to the DC/AC single-phase inverter 522 for delivery to the AC grid connection 108, or receive power from the AC grid connection 108 through the DC/AC single-phase inverter 522 to provide that power to the first DC link 506, at the voltage corresponding to the voltage determined by MPPT processing, where that power is then converted by the bidirectional buck-boost converter 504 to charge the battery 132 through the battery port 106.

In further examples, the bidirectional buck-boost converter 504 performs MPPT processing to adjust the first DC voltage on the first DC link 506 to maximize the electrical power production by the PV component 130. In such examples, the bidirectional CLLC converter 520 adjusts its operation to match the first DC voltage set by the bidirectional buck-boost converter 504.

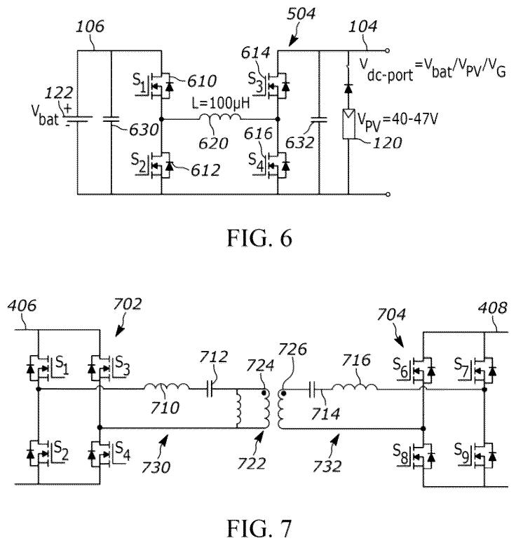

FIG. 6 illustrates a bidirectional buck-boost converter block diagram 600, according to an example. The bidirectional buck-boost converter block diagram 600 is an example of a schematic diagram of, for example, a first bidirectional boost converter 320 of the first microinverter system block diagram with a non-isolated hybrid microinverter configuration 300, of the second boost inverter 402 of the second hybrid microinverter system block diagram with an isolated hybrid microinverter configuration 400, or of the bidirectional buck-boost converter 504, of the third microinverter system block diagram 500, discussed above. The bidirectional buck-boost converter block diagram 600 operates to efficiently manage the voltage from the PV or AC side to charge the battery and deliver regulated voltages to meet the system's requirements.

The bidirectional buck-boost converter block diagram 600 includes the above described battery 132 and PV component 130. The battery 132 is connected through the battery port 106 across a first transistor 610 and a second transistor 612.

The PV component 130 is connected through the PV port 104 to a third transistor 614 and a fourth transistor 616. One end of an inductor 620 is connected to the connection between the first transistor 610 and the second transistor 612, and the other end of inductor 620 is connected to the connection between the third transistor 614 and the fourth transistor 616. A battery capacitor 630 is connected across the battery port 106 to stabilize the voltage across the first transistor 610 and the second transistor 612. A PV cell capacitor 632 is connected across the PV port 104 to stabilize the voltage across the third transistor 614 and the fourth transistor 616. As shown, the bidirectional buck-boost converter block diagram 600 couples the ground voltage levels, e.g. the lower connections of the PV port 104 and the battery port 106, to one another to provide a non-isolated coupling.

In various examples, a controller (not shown) controls the first transistor 610, the second transistor 612, the third transistor 614, and the fourth transistor 616 to perform the operations described herein. In an example, the bidirectional buck-boost converter block diagram 600 depicts a block diagram corresponding to the second boost inverter 402 or the bidirectional buck-boost converter 504, and the controller (not shown) controls these transistors to implement MPPT processing to maximize the electrical power transfer from the PV component 130.

An example of a bidirectional buck-boost converter suitable for incorporation into a hybrid microinverter system has the following characteristics. A battery port voltage of between 45-53V depending on the battery charge state change. DC-port Voltages of 40-47V to charge the battery 132 from the PV component 130, to accommodate MPPT operations, and 52V when charging the battery from power received from the AC grid connection 108. In such an example, a power handling capacity of 560 W with measured efficiencies of approximately 90.5%.

FIG. 7 illustrates a Capacitor Inductor Inductor Capacitor (CLLC) converter block diagram 700, according to an example. The CLLC converter block diagram 700 depicts a circuit of, for example, the bidirectional CLLC resonant converter 420, or the bidirectional CLLC converter 520 that are discussed above. The CLLC converter block diagram 700 depicts a circuit that is used within the described three-port systems to facilitate seamless integration of Photovoltaic (PV), battery, and grid/load interfaces.

For purposes of the present description, a CLLC converter and a CLLLC resonant converter are able to be considered as similar constructs. A bidirectional CLLC converter, or CLLLC resonant converter, with bidirectional power flow capability and soft switching characteristics has been found to be an effective component of hybrid microinverter systems. Bidirectional CLLC converters have been found to be effective in the presently described applications because such converters achieve high efficiency, high power, and high density. A CLLC converter, which has a symmetric tank circuit, is capable of bidirectional operation. A bidirectional CLLC structure is advantageously employed in these examples since it allows better control of the switching frequency and an additional degree of freedom on gain.

The CLLC converter block diagram 700 depicts a first transistor bridge 702 that consists of four (4) transistors in a bridge arrangement to selectively connect the two conductors of the first DC link 406 to a first CLLC connection 730. The first CLLC connection 730 includes a series connected first inductor 710 and a first capacitor 712 that connects to a first winding 724 of a transformer 722 in parallel with a second indictor 720. A second CLLC connection 732 is formed by a second winding 726 of the transformer 722 that is connected to a series connected second capacitor 714 and a second inductor 716. The transformer 722 in the illustrated example isolates the ground voltage levels between the first DC link 406 and the second DC link 408. A second transistor bridge 704 consists of another four (4) transistors in a bridge arrangement to selectively connect the two conductors of the second CLLC connection 732 to the two conductors of the second DC link 408.

An example of a bidirectional CLLC converter suitable for incorporation into a hybrid microinverter system has the following characteristics. An input voltage of between 40-53V. output voltage of 380V. In such an example, a power handling capacity of 700 W with measured efficiencies of around 92%. In an example the bidirectional CLLC converter operates with an adjustable switching frequency with a range of 80-160 kHz. In practical terms, the bidirectional CLLC converter can operate below, at, or above its resonant frequency. Experimental testing has been conducted to assess a converter's performance at its resonant frequency, specifically at 100 kHz.

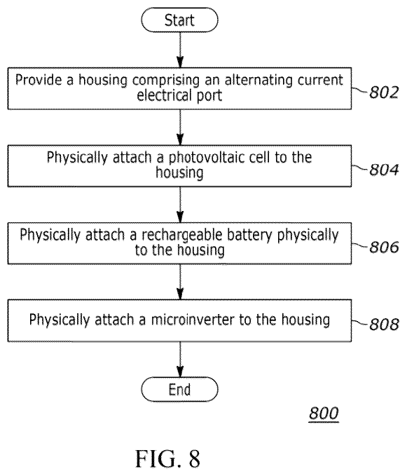

FIG. 8 depicts a method of providing an integrated photovoltaic power module 800, according to an example. This example method is able to provide an integrated photovoltaic power module that has an integrated microinverter as is described above.

The method of providing an integrated photovoltaic power module 800 provides, at 802, a housing comprising an alternating current electrical port. An example of such a housing is the above described frame 204, which has a hybrid microinverter 224 that has an AC grid connection 108.

A photovoltaic cell, such as photovoltaic cell 202, is attached physically, at 804, to the housing, such as frame 204. A rechargeable battery, such as rechargeable battery 222, is physically attached to the housing, such as the frame 204, at 806. A microinverter, such as the hybrid microinverter 224, is physically attached to the housing, such as frame 204, at 808. The method of providing an integrated photovoltaic power module 800 then ends.

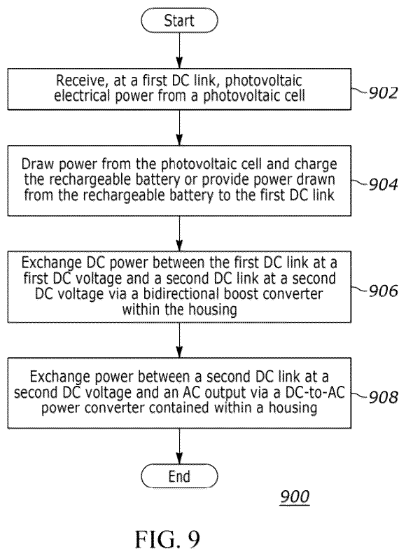

FIG. 9 depicts a method of providing electrical power from a photovoltaic module 900, according to an example. The method of providing electrical power from a photovoltaic module 900 depicts a method of operating an integrated photovoltaic power module such as the module described above.

The method of providing electrical power from a photovoltaic module 900 receives, at 902 at a first DC link, photovoltaic electrical power from a photovoltaic cell. Power is drawn, at 904, from the photovoltaic cell to charge the rechargeable battery or provide power drawn from the rechargeable battery to the first DC link. In some examples, drawing power from the photovoltaic cell includes performing MPPT processing to adjust the voltage present on the first DC link.

DC power is exchanged, at 806, between the first DC link at a first DC voltage and a second DC link at a second DC voltage via a bidirectional boost converter within the housing. Power is exchanged, at 908, between a second DC link at a second DC voltage and an AC output via a DC-to-AC power converter contained within a housing. The method of providing electrical power from a photovoltaic module 900 then ends.

### The Systems and Methods Described Herein Provide the Following Advantages

1—Plug and play: these systems and methods provide a PV system that can be installed fast and easily since the battery, PV and hybrid microinverter are integrated
2—lower space: the combination of the PV and battery advantageously reduce the number of required PV panels relative to conventional PV panel installations.
3—Portable sources: These systems and methods do not need any specific installation and thus can be carried to any location and be used as a power source. Such characteristics are very useful in poor countries that do not have access to sustainable energy.
4—Monitoring: the described systems and methods include a PV and combined hybrid microinverter systems that can each be monitored and managed by their installed firmware. Solar power harvesting is able to be more closely monitored by the monitoring each such PV and combined hybrid microinverter systems.

These systems and methods are applicable for installation in residential and industrial applications. Utility applications are another use to implement these systems and methods within, for example, a PV farm since the integration of the PV and battery provides a stable power source.

These systems overcome challenges of existing systems where the PV, battery, and hybrid inverter are separate. In such cases where these components are separate, preparing and installing the whole system can be challenging. These systems introduce a hybrid microinverter that is at the PV power level. These systems in some examples are very easy to install as a plug and play system and customers can benefit from the AC outlet of this integrated system.

The above addresses energy access issue by providing sustainable and plug-and-play energy sources. These systems and methods give easy energy access by providing sustainable electricity and possibly allow for energy arbitrage. Such systems and methods are able to be integrated into other equipment, such as air conditioners.

The specification and figures are to be regarded in an illustrative rather than a restrictive sense, and all such modifications are intended to be included within the scope of the present invention. Any benefits, advantages or solutions to problems described herein with regard to specific embodiments are not intended to be construed as a critical, required or essential feature or element of any or all the claims. Unless stated otherwise, terms such as “first” and “second” are used to arbitrarily distinguish between the elements such terms describe.

Thus, these terms are not necessarily intended to indicate temporal or other prioritization of such elements. Note that the term “couple” has been used to denote that one or more additional elements may be interposed between two elements that are coupled such that the one or more additional elements are able to be one of directly coupled without intermediate elements or indirectly coupled in which case intermediate elements are able to be present within the coupling structure.

Although the invention is described herein with reference to specific embodiments, various modifications and changes can be made without departing from the scope of the present invention as set forth in the claims below.

1. An integrated photovoltaic power module, comprising:
a photovoltaic cell;
a rechargeable battery;
an alternating current electrical port; and
a microinverter comprising:
a first DC link at a first DC voltage, wherein a power output from the photovoltaic cell is electrically coupled, one of directly or indirectly, to the first DC link;
a second DC link at a second DC voltage;
a bidirectional boost converter configured to, when operating, convert DC power between the first DC link at the first DC voltage and the second DC link at the second DC voltage;
a DC-to-AC power converter configured to, when operating, exchange electrical power between the second DC link with the second DC voltage and the alternating current electrical port at an AC voltage; and
a bidirectional battery voltage converter comprising a battery port and battery converter power port, the battery port electrically connected to the rechargeable battery and the battery converter power port connected to the first DC link, the bidirectional battery voltage converter configured to, when operating, convert between a voltage of the rechargeable battery and the first DC voltage.

2. The integrated photovoltaic power module of claim 1, wherein the bidirectional battery voltage converter is an interleaved boost converter.

3. The integrated photovoltaic power module of claim 2, where the bidirectional boost converter couples ground voltage levels between the first DC link and the second DC link.

4. The integrated photovoltaic power module of claim 1, wherein the bidirectional boost converter comprises a bidirectional CLLC converter.

5. The integrated photovoltaic power module of claim 4, where the bidirectional CLLC converter isolates ground voltage levels between the first DC link and the second DC link.

6. The integrated photovoltaic power module of claim 1, further comprising:
a photovoltaic cell output boost converter electrically coupling the power output from the photovoltaic cell to the first DC link, the photovoltaic cell output boost converter configured to, when operating, convert the power output from the photovoltaic cell to the first DC voltage.

7. The integrated photovoltaic power module of claim 6, wherein the photovoltaic cell output boost converter is further configured to, when operating, perform maximum power point tracking for the power output of the photovoltaic cell.

8. The integrated photovoltaic power module of claim 1, wherein:
the power output from the photovoltaic cell is connected directly to the first DC link and the battery converter power port; and
the first DC voltage corresponds to an output voltage of the photovoltaic cell.

9. The integrated photovoltaic power module of claim 8, wherein
the bidirectional boost converter is further configured to, when operating, perform maximum power point tracking for the output voltage of the photovoltaic cell, and
the bidirectional battery voltage converter is further configured to, when operating, follow the maximum power point tracking for the output voltage of the photovoltaic cell.

10. A method of providing electrical power from a photovoltaic module, the method comprising:
receiving, at a first DC link, photovoltaic electrical power from a photovoltaic cell;
exchanging electrical power between a rechargeable battery and the first DC link via a bidirectional battery voltage converter;
exchanging DC power between the first DC link at a first DC voltage and a second DC link at a second DC voltage via a bidirectional boost converter; and
exchanging power between a second DC link at a second DC voltage and an AC output via a DC-to-AC power converter.

11. The method of claim 10, wherein the bidirectional battery voltage converter is an interleaved boost converter.

12. The method of claim 11, where the bidirectional boost converter couples ground voltage levels between the first DC link and the second DC link.

13. The method of claim 10, wherein the bidirectional boost converter comprises a bidirectional CLLC converter.

14. The method of claim 13, where the bidirectional CLLC converter isolates ground voltage levels between the first DC link and the second DC link.

15. The method of claim 10, wherein receiving, at a first DC link, photovoltaic electrical power further comprises electrically coupling the photovoltaic electrical power to the first DC link via a photovoltaic cell output boost converter that is configured to, when operating, convert the photovoltaic electrical power to the first DC voltage.

16. The method of claim 15, wherein the photovoltaic cell output boost converter is further configured to, when operating, perform maximum power point tracking for the output of the photovoltaic cell.

17. The method of claim 10, wherein receiving, at a first DC link, photovoltaic electrical power further comprises electrically coupling the photovoltaic electrical power to the first DC link via a direct link, and
wherein the first DC voltage corresponds to an output voltage of the photovoltaic cell.

18. The method of claim 17, wherein the bidirectional boost converter is further configured to, when operating, perform maximum power point tracking for the output voltage of the photovoltaic cell, and
the bidirectional battery voltage converter is further configured to, when operating, follow the maximum power point tracking for the output voltage of the photovoltaic cell.
